(19) United States
(12) Patent Application Publication
(10) Pub. No.: US 2005/0200116 A1
(43) Pub. Date: Sep. 15, 2005

(54) Electronic book reading apparatus

(75) Inventor: Andrew Shun Pui Chiu, Tsimshatsui East Kowloon (CN)

Correspondence Address: WILLIAM J. SAPONE;COLEMAN SUDOL SAPONE P.C., 714 COLORADO AVENUE, BRIDGE PORT, CT, 06605, US

(73) Assignee: Ngai Keung Metal & Plastic Manufactory Limited, Tsimshatsui East Kowloon (CN)

(21) Appl. No.: 11/072,182

(22) Filed: Mar. 4, 2005

(30) Foreign Application Priority Data
Mar. 9, 2004 (CN) 2004200443276.X

(51) Int. Cl. B42D 1/00

(52) U.S. Cl. 281/15.1

(57) ABSTRACT

An electronic book reading apparatus, comprising means for receiving a book in an open position having a plurality of pages, memory means for storing the content of the book in digital form, magnetic detecting means for detecting at which page the book is open, and means for retrieving from the memory means digital content corresponding to the page and outputting the content as an audio signal.

### FIELD OF THE INVENTION

The present invention is concerned with an electronic book reading apparatus which may be used as an educational tool or toy to assist children to learn. The present invention is also concerned with an assembly comprising such an apparatus and a book for use with the apparatus. The present invention is also concerned with a book for use with such an apparatus.

### BACKGROUND OF THE PRESENT INVENTION

There are a variety of electronic book reading apparatuses on the market. Typically, these apparatus are able to identify contents of respective books and output audio signals corresponding to the contents. These apparatuses allow, for example, children to learn more effectively while reading.

One type of such an apparatus is usually sold with the respective books and corresponding data cards which are together called electronic books. This apparatus is often provided with a slot into which the data card may be inserted. The apparatus typically comprises a base defining a surface on which the book may be placed. The base is provided with a number of activation switches at different positions of the surface. In use, when a book is placed on the base and a predetermined location or icon on the page of interest is pressed, the corresponding activation switch on the base beneath the predetermined location becomes activated under pressure and the apparatus will output an audio signal corresponding to the content of the page. Accordingly, the user can listen to the signal and perceive the content of the page.

FIG. 1 shows an activation switch 1 often used in conventional electronic books. The switch is of a type operable on pressing thereof. The switch comprises two overlapping metallic leaf springs 2, 4 which are not in contact by default. The springs are covered by a thin protective cover 6. In use, the upper leaf spring 2 is downwardly pressed and the two springs 2, 4 then come into contact with each other, and as a result the circuit connecting to the switch becomes closed. When the upper leaf spring 2 is released, it returns to its default position and the circuit becomes open.

However, this type of conventional electronic book is undesirable for a number of reasons. First, the icons on the different pages cannot overlap and this limits the presentation of contents on the pages of the book. Second, since there is a plurality of the switches scattered on the base, the structure of the base becomes complicated and is costly to manufacture. Third, for similar reasons the thickness and/or number of the pages, and the material for making the pages, of the book are limited. If there are too many pages or the pages are too thick then some or all of the switches would not be operable despite pressure being applied on the respective icons of the pages.

The present invention seeks to provide an electronic book reading apparatus addressing the above problems, or at least to provide the public with an alternative.

### SUMMARY OF THE INVENTION

According to a first aspect of the present invention, there is provided an electronic book reading apparatus, comprising means for receiving a book having a plurality of pages, memory means for storing the content of the book in digital form, detecting means (preferably magnetic detecting means) for detecting at which page the book is open, and means for retrieving from the memory means digital content corresponding to the page and outputting the content as an audio signal.

Preferably, the detecting means may be adapted to detect identification means associated with the pages of the book, wherein each of the pages is provided with a unique identification member of the identification means, and wherein the memory means stores the content of the book in a manner such that the content of each of the pages can be retrieved.

Suitably, the identification member may comprise a magnetic tag for activating the detecting means. As described above, the detecting means may preferably be a magnetic means, comprising magnetic switches, adapted to detect the magnetic tags although the detecting means may be an optical detecting means in certain circumstances.

Advantageously, the identification members may be located at different positions on the pages respectively, and wherein the detecting means may comprise a plurality of the magnetic means located at positions corresponding to the positions of the identification members when the book is received by the apparatus for detecting at which page the book is open.

Preferably, the memory means may be a solid-state memory card which may be inserted to the apparatus. Alternatively, the content of the solid-state memory card may be changed from a remote location, and in such case signal may be transmitted to the apparatus from the remote location. The solid-state memory card may be removable whereby the card may be removed and replaced by another card with different content for use with a different book.

Suitably, the receiving means may comprise a base defining a supporting surface sized and shaped to accommodate the book.

The retrieving means may comprise an integral loudspeaker for outputting the audio signal in an audible form, the audio signal corresponding to the content of the page at which the book is open.

According to a second aspect of the present invention, there is provided an assembly comprising an electronic book reading apparatus as described above and a book for use with the apparatus, wherein the book comprises a plurality of pages bound together at one side thereof, or at an elongate member in the form of a spine. The book may be provided at the other side opposite to the spine on the pages a plurality of the identification members. In particular, the identification members may comprise non-overlapping regions for activating the detecting means, and the identification members are preferably sized and shaped to be easily flicked by a finger when turning the pages.

Preferably, the base may be provided with an elongate recess for accommodating the elongate member. In particular, the elongate member may be in the form of an axle adapted to removably secure the book with the base unit.

Suitably, the side of the book provided with the identification members may be inwardly curved. This configuration allows reduction of empty space on the pages and easier flipping of the pages. In particular, the identification members may be evenly distributed on the inwardly curved side. An upper side or lower side of the pages of the book may preferably be outwardly or inwardly curved for providing more interesting curvature to the book.

Advantageously, the apparatus may comprise a cover member attached thereto. The detecting means may be provided at or in the cover member, or at another suitable location adjacent to or beneath the identification members in use.

### BRIEF DESCRIPTION OF THE DRAWINGS

An embodiment of the invention is described, by way of example only, with reference to the following drawings in which:

FIG. 1 is a schematic drawing showing a magnetic switch used in conventional electronic books;

FIG. 2 is a schematic drawing showing a magnetic detecting switch which may be used in accordance with the present invention;

FIG. 3 is an electronic book reading apparatus in a closed configuration suitable for storage;

FIG. 4 is the apparatus shown in FIG. 3 but in an operable configuration;

FIG. 5 is a book for use with the apparatus shown in FIG. 3;

FIG. 6 is an assembly comprising the apparatus shown in FIG. 3 and the book shown in FIG. 5; and

FIG. 7 is a schematic cross section view showing a magnet residing in a tag of page of the book.

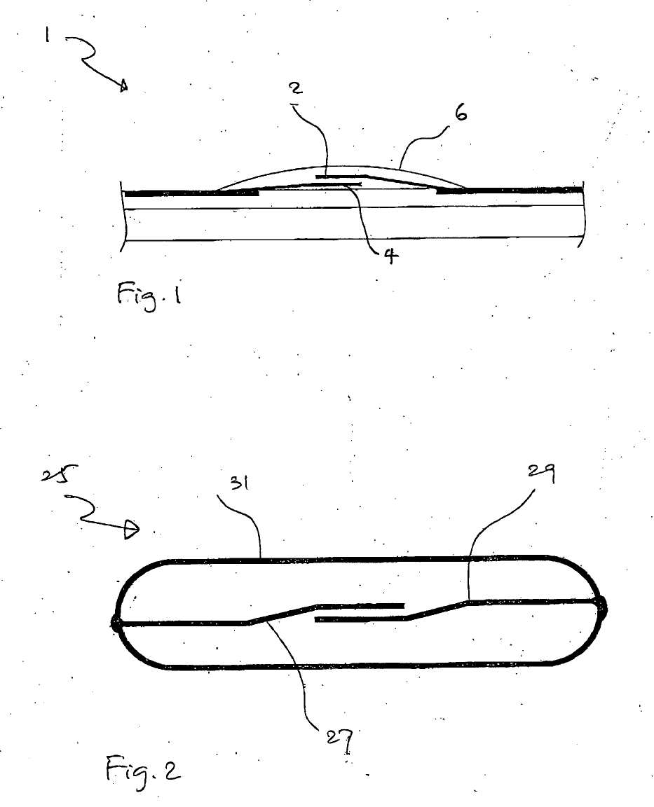

### DETAILED DESCRIPTION OF A PREFERRED EMBODIMENT

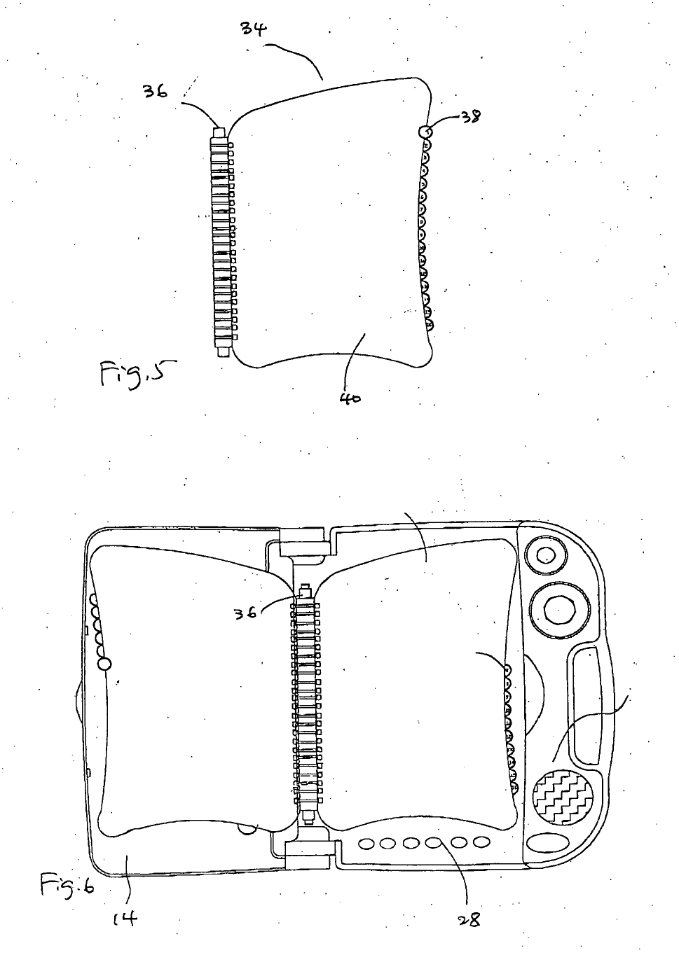

Referring firstly to FIGS. 3 and 4, there is shown an electronic book reading apparatus generally designated 10. The apparatus 10 comprises a base 12 and a cover 14 pivotably connected thereto. The base 12 is provided with an elongate recess 16 at one side 18 thereof. In FIG. 3, the apparatus 10 is in a stowed configuration suitable for storage while in FIG. 4, it is in an operable configuration in which it is ready to receive a respective book of interest. The upper surface 20 of the base and the cover 14 together define a region 22 for accommodating the book.

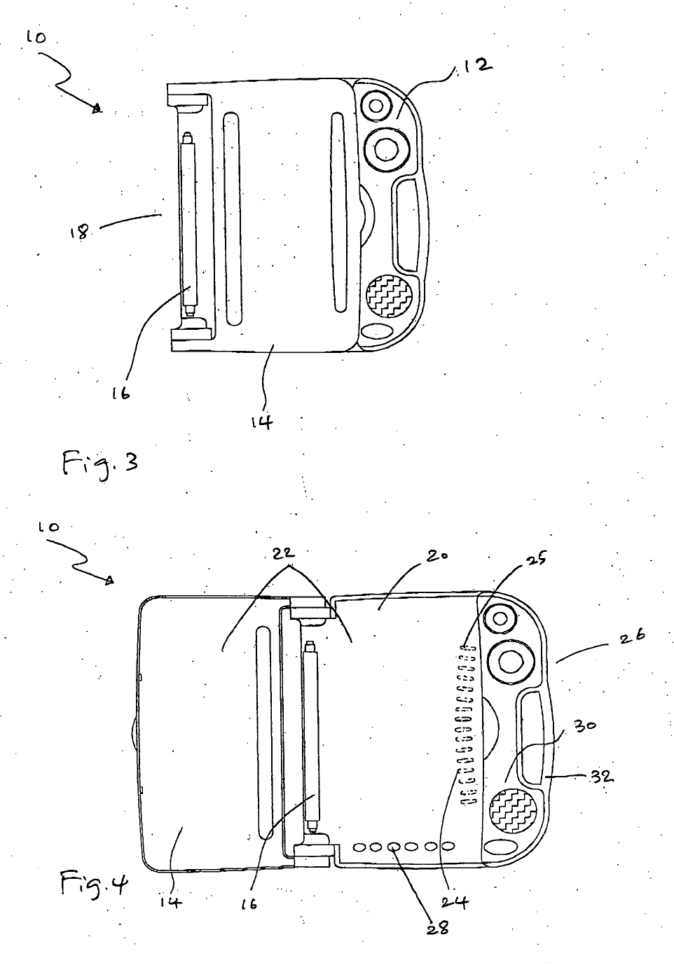

As shown in FIG. 4, the apparatus 10 is provided with a magnetic detecting means 24 comprising a number of magnetic switches 25 arranged in a slightly curved configuration at the side 26 of the apparatus opposed to the side 18 having the elongate recess 16. The base 12 is also provided with a number of operating buttons 28 at the lower end, a speaker 30 at the lower right hand corner and a handle 32 at the right side thereof. The base 12 is also provided with a processing chip for processing signals transmitted from the magnetic switches 25 and a memory unit for storing information in digital format corresponding to a respective book categorized according to pages (not shown in the figures). The memory unit is in the form of solid-state memory card. An example of the magnetic switch 25 is shown in FIG. 2. Similar to the switch 1, the magnetic switch 25 also comprises two leaf springs 27, 29 which normally stay apart but they become in contact when a magnet is brought above a rigid glass capsule 31 enclosing the springs 27, 29.

FIG. 5 shows a respective book 34 for use with the apparatus 10. The book 34 comprises a number of pages 40 which are bound at the left side by wires to form a spine 36 which is elongate in shape. Each page 40 is provided with a tag 38 protruding from the page. The tags 38 of the pages 40 together serve as an index for the book 34. A magnet 40 is provided within each tag 38 for interacting with the respective magnetic switch 25 of the detecting means 24, an example of the tag is shown in FIG. 7. The tags 38 are arranged in a slightly curved configuration at the right side on the book 34 corresponding to the configuration of the magnetic switch 25.

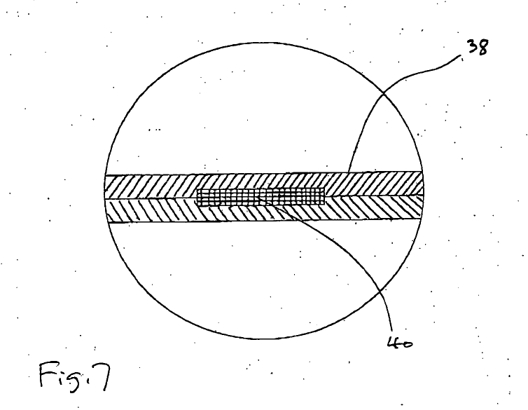

FIG. 6 shows the apparatus 10 fitted with the book 34. The recess 16 of the base 12 is sized and shaped such that it allows a tight fit of the elongate member 36 therewith and the pages 40 can be turned at the spine 36 engaged with the recess 16.

The book 34 in this embodiment has sixteen pages as illustrated by the numbers on the index on the tags 38. However, for the purpose of explaining the operation of the apparatus 10, it is assumed that the book 34 including the front and back covers has only four pages, i.e. page one (front cover), page two, page three and page four (rear cover), and the detecting means 24 has only four corresponding magnetic switches 25. When the book 10 is closed with all the four pages at the right hand side of the apparatus 10, i.e. the front cover of the book 10 is upwardly facing, all the magnets 40 within the tags 38 of the four pages 40 lie above the four switch means 25, and through the magnetic force interact with the switch means 25 such that the circuit of all the switches are closed. The processing chip detects the signal of the detecting means 24 corresponding to this configuration of the switches 25, retrieves the relevant information from the memory unit and outputs a signal corresponding to the respective content of the front cover to the speaker 30. It can thus be understood that the apparatus 10 then automatically reads the content of the front cover 30 when the user merely places the closed book on the apparatus 10.

When the user turns to page two, the magnet 40 in the tag 38 of the front cover becomes magnetically disengaged from the respective switch 25 and as a result the circuit of that switch 25 becomes open while that of the other switches 25 remain closed. The processing chip detects the signal of the detecting means 24 corresponding to this different configuration of the four switches, retrieves the relevant information from the memory unit and outputs a signal corresponding to the content of page two to the speaker 30. The apparatus 10 automatically reads the content of page two after the user turns the book 34 to page two. The following table summarizes the configuration of the magnetic switches with respect to the page at which the book is open.

TABLE 1
Relationship of the state of the switch means and the book
opened at which page

| Book at page 1/ | | | | |
|---|---|---|---|---|
| Configuration | | | | Page four |
| of switches/ | Page one | | | (rear |
| Circuit of switches | (front cover) | Page two | Page three | cover) |
| 1 | Closed | Closed | Closed | Closed |
| 2 | Open | Closed | Closed | Closed |
| 3 | Open | Open | Closed | Closed |
| 4 | Open | Open | Open | Closed |

An apparatus in accordance with the present invention generally adopts a binary principle of operation to be explained as follows. A magnetic switch 25 which has a closed circuit corresponds to “0” while a magnetic switch 25 which has an open circuit corresponds to “1”. When the book 34 is closed and properly located in the apparatus 10, the configuration of the four switches can be represented by the number “0-0-0-0”. When the book is turned to page two, the configuration will become “1-0-0-0”. It can thus be understood that any particular configuration of the above book 34 can be represented by a four-digit binary number.

In use, a respective book of interest is properly placed on the apparatus with a corresponding memory card inserted to the apparatus. Depending on the page at which the book is open, the speaker of the apparatus will output an audio sound corresponding to the content of that page. When a different book is placed on the apparatus and open at a particular page with a respective memory card inserted to the apparatus, the apparatus will output an audio signal corresponding to the content of the particular page of that book.

While the memory unit of the above embodiment is a solid-sate memory card adapted to be inserted to the apparatus, it is envisaged that in an alternative embodiment the memory unit may be located in an independent means remotely located away from the apparatus and the content of the memory unit may be accessible by the apparatus by wireless communication. For example, the apparatus may be provided with an accessory not connected thereto but associated with a personal computer. The accessory of the computer may comprise a memory unit storing contents of a plurality of respective books. The content of any particular respective book may be transmitted from the accessory to the apparatus by wireless communication. The personal computer associated with the accessory may be used to control which content of the respective books comprised in the memory unit be transmitted to the apparatus. Alternatively, the accessory may be a stand-alone unit having a slot to which a respective memory card may be fitted, and the card may be removed and replaced with another respective card when a corresponding book is used on the apparatus. Yet alternatively, the accessory may be provided with multiple slots inserted with multiple respective memory cards or files, and one of those respective cards or files may be selected in use.

While the detecting means in the above embodiment is in the form of a magnetic means, it is envisaged that it may be in the form of an optical detecting means such that the presence (or absence) of the tags at the right side of the apparatus may be detected optically and as such at which page the book is open can likewise be detected. It is to be noted that a skilled person in the art on reading this disclosure would be able to make such modifications.

It is to be noted that the above detecting means is activated by magnetic force which can penetrate papers of reasonable thickness, and the activation of the detecting means does not depend on pressure on the switches. As such, the book may be made with virtually any reasonable number of pages and the pages may be made with relatively thick papers.

1. An electronic book reading apparatus, comprising means for receiving a book in an open position having a plurality of pages, memory means for storing the content of said book in digital form, magnetic detecting means for detecting at which page said book is open, and means for retrieving from said memory means digital content corresponding to said page and outputting said content as an audio signal.

2. Apparatus as claimed in claim 1 wherein said detecting means is adapted to detect identification means associated with the pages of said book, wherein each said page is provided with a unique identification member of said identification means, and wherein said memory means stores the content of said book in a manner such that the content of each of said pages can be retrieved.

3. Apparatus as claimed in claim 2 wherein said identification member comprises a magnetic tag.

4. Apparatus as claimed in claim 3 wherein said detecting means comprises a magnetic switches adapted to detect said magnetic tags.

5. Apparatus as claimed in claim 2 wherein said identification members are located at different positions on the pages respectively, and wherein said detecting means comprises a plurality of means located at positions corresponding to the positions of said members when said book is received by said apparatus for detecting at which page said book is open.

6. Apparatus as claimed in claim 1 wherein said memory means is a solid-state memory card.

7. Apparatus as claimed in claim 6 wherein the content of said solid-state memory card is changeable from a remote location.

8. Apparatus as claimed in claim 6 wherein said solid-state memory card is removable whereby said card may be removed and replaced by another card with different content.

9. Apparatus as claimed in claim 1 wherein said receiving means comprises a base defining a supporting surface sized and shaped to accommodate said book.

10. Apparatus as claimed in claim 1 wherein said retrieving means comprises an integral loudspeaker for outputting said audio signal in an audible form.

11. An assembly comprising an electronic book reading apparatus as claimed in claim 1 and a book suitable for use with said apparatus, wherein said book comprises a plurality of pages bound together at an elongate member.

12. An assembly as claimed in claim 11 wherein said book is provided at the other side opposite to the elongate member will a plurality of said identification members.

13. An assembly as claimed in claim 12 wherein said identification members comprise non-overlapping regions for activating said detecting means.

14. An assembly as claimed in claim 11 wherein said base is provided with an elongate recess for accommodating said elongate member of said book.

15. An assembly as claimed in claim 11 wherein said elongate member is in the form of an axle adapted to removably secure the book with said base.

16. An assembly as claimed in claim 1 wherein the side of said book provided with the identification members is inwardly curved.

17. An assembly as claimed in claim 11 said identification members are evenly distributed on the inwardly curved side.

18. An assembly as claimed in claim 11 wherein an upper side or lower side of the pages of said book is outwardly or inwardly curved.

19. An assembly as claimed in claim 11 wherein said apparatus comprises a cover member attached thereto.

20. An assembly as claimed in claim 219 wherein said detecting means is provided at or in said cover member.

21. A book adapted to be use with an apparatus as claimed in claim 1 comprising identification means detectable by said magnetic detecting means of said apparatus.
